(19) United States
(12) Patent Application Publication
(10) Pub. No.: US 2006/0031151 A1
(43) Pub. Date: Feb. 9, 2006

(54) System and method for a life settlement and/or viatical exchange

(76) Inventor: David C. Dorr, Miami Beach, FL (US)

Correspondence Address: PATTON BOGGS LLP, 8484 WESTPARK DRIVE, SUITE 900, MCLEAN, VA, 22102, US

(21) Appl. No.: 10/895,112

(22) Filed: Jul. 21, 2004

(51) Int. Cl. G06Q 40/00

(52) U.S. Cl. 705/37; 705/4

(57) ABSTRACT

A life exchange system and method for life settlement and/or viaticals are provided where a plurality of life insurance policies can be sorted and matched between brokers and funders. The life exchange system allows brokers and providers to exchange secondary life insurance by way of a life exchange component including a plurality of secondary life insurance policies submitted by brokers registered with the life exchange. Multiple registered providers can receive, request and bid on these policies, which meet specified criteria. By sorting and matching uniquely identified cases and providers, exchanges are made.

### FIELD OF THE INVENTION

The invention relates generally to life insurance exchange and, more particularly to a system and method for a life settlement and/or viatical exchange in accordance with the principles of the invention.

### BACKGROUND OF THE INVENTION

The word “viaticus” means to take a journey in Latin. This is the root of the word viatical. The viatical industry came about in the late 1980's as several AIDS patients found themselves with a then terminal illness and life insurance policies that were unwanted because of increased medical costs, for example. A life insurance policy is an asset just like a stock or bond and can be transferred for value. Accordingly, AIDS patients were offered a lump sum payment of cash above their cash surrender value in exchange for transferring the ownership and beneficiary of the policy to a third party. This industry is referred to as the “viatical” industry. Over time this industry has grown rapidly and unfortunately without much regulation, which leads to fraud from both viators, and investors that were present in this industry.

Over the last five (5) years or so, however, the market has evolved into an industry that is heavily regulated and institutionally backed. The main cause for this has been because of the growing senior population and the constant estate changing needs they face. This industry has been called the “life settlement” industry or the “senior settlement” industry.

There are several key players in this field. First there are the buyers of the policy or asset, also known as the funders. These buyers can be large institutions including, for example, Merrill Lynch, Berkshire Hathaway, Maple Financial, GenRe, GE Capital, AIG, Deutsche Bank, and many more. These institutions invest billions of dollars in these policies, which can be considered asset-backed securities earning yields in many circumstances in excess of 25%. The funders use licensed “provider” entities that hold the appropriate licenses to purchase these policies. Many providers can purchase policies directly from the insured or solicit life insurance agents, estate planners, CPA's or other financial intermediaries to acquire policies. Almost all providers can buy policies from life settlement/viatical brokers because of the large amount of deal flow that brokers control.

Brokers are in the market to represent the insured. A broker can act on behalf of the insured and try to take their policy to multiple funders in an effort to have the funders bid against each other for the highest price to obtain a policy. Brokers genuinely help create the secondary market for life insurance policies. Brokers work with the insured or their life insurance agents or financial planners. Brokers are required to be licensed in every state in which they broker policies.

The Viatical and Life Settlement Association of America (“VLSAA”) is a regulatory body for this industry. The VLSAA works on creating new laws and regulations to protect the consumer and prevent fraud. But, currently there remains a need to provide a way to prevent fraud and protect consumers. As this market grows in both volume and complexity there is an ever-increasing need for the efficient facilitation of life settlement/viatical transactions including compliance with current regulations.

### SUMMARY OF THE INVENTION

One aspect of the invention relates to an insurance exchange product for providing exchange capabilities between brokers and providers. The product can include a broker registered with a life insurance exchange, a plurality of providers registered with the life insurance exchange and a life insurance packet submitted to the life insurance exchange. The life insurance packet is capable of being matched with qualified providers. The broker and provider are registered with the life exchange. The provider has at least one identifier, the life insurance packets each have at least one packet identifier and a match can be created when the provider's identifier matches at least one of the packet identifiers.

The life insurance exchange can include a life exchange component having a database of at least a plurality of life insurance packets. The life insurance packet can include a life insurance policy and the identifier includes at least one of a statement of ownership of the life insurance policy, a face value of the life insurance policy, carrier rating, policy type and a life expectancy range for an individual insured under the life insurance policy.

The provider's identifier includes at least one purchasing parameter. The purchasing parameters can include at least one of a face value range, a policy type, a life expectancy range and a state of licensing. The product further comprises bidding means for the provider to submit a bid on the life insurance packet to the broker. Additionally, the product can include a plurality of life insurance packets identified as a portfolio.

The insurance exchange can be either a life settlement exchange or a viatical exchange. The broker can be a broker brokering life settlement and/or viaticals.

The invention also can include a system for an insurance exchange including storage means for storing a plurality of life insurance policy packets and at least one provider profile, wherein each policy packet has a packet identifier and the provider profile has a provider identifier, sorting means for sorting the plurality of policy packets based on the identifiers, matching means for matching the policy packet and the provider profile based on the identifiers to identify at least one match, and means for forwarding the match to the provider.

The packet identifier can include a plurality of searchable parameters. The parameters include at least one of a state of ownership of the life insurance policy, a face value of the life insurance policy and a life expectancy range for an individual insured under the life insurance policy. The provider identifier can include a plurality of searchable parameters. The parameters can include at least one of a face value range, a policy type, a life expectancy range and a state of licensing.

A further embodiment provides a computer implemented method of providing an insurance exchange, including submitting insurance policy data for a plurality of life insurance policies into a life exchange component, wherein each insurance policy has a profile, requesting identification of policies having a requested profile, sorting the insurance policy data to identify a match based on the requested profile, sending a match, if identified, to the requestor, and allowing the requester to submit through the life exchange component a bid to purchase the matched life insurance policy. The step of sorting includes identifying a plurality of matched life insurance policies and bundling them into a portfolio. The system also can provide for notifying the providers of a bid on the match.

Additional features, advantages and embodiments of the invention may be set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detailed description serve to explain the principles of the invention. In the drawings:

FIG. 1 is a diagram showing an embodiment of the structure of the life exchange according to the principles of the invention.

FIG. 2 illustrates an embodiment of a platform that is used to implement the life settlement and/or viatical exchange according to the principles of the invention.

FIG. 3 is a diagram of the broker and funder accounts and life insurance case submissions according to the principles of the invention.

FIG. 4 is a flow diagram illustrating an embodiment of the life exchange method according to the principles of the invention.

### DETAILED DESCRIPTION OF THE PREFERRED EMBODIMENTS

Reference can now be made in detail to the preferred embodiments of the present invention, examples of which are illustrated in the accompanying drawings. The present invention described below includes, generally, a system and method for providing a life settlement and/or viatical exchange where a plurality of life insurance policies can be sorted and matched between brokers and funders.

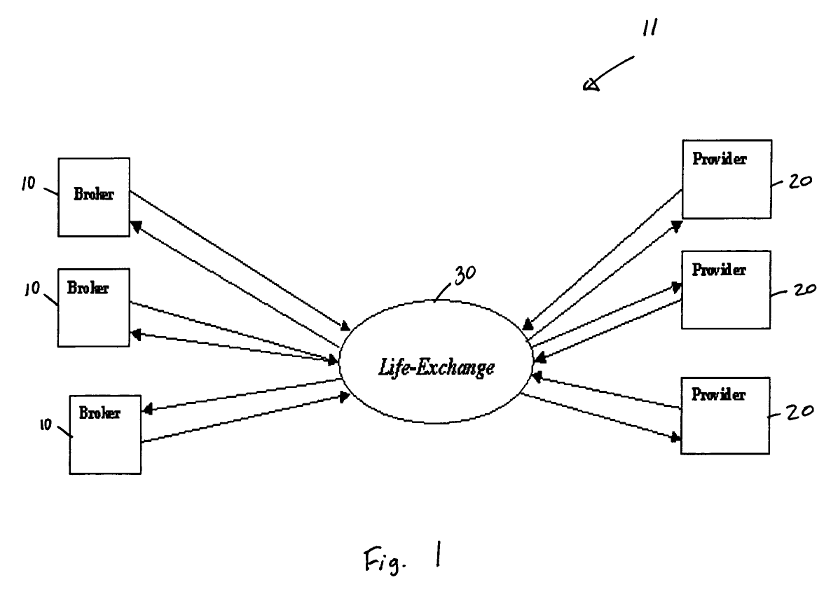

The invention is directed to a life settlement and/or viatical exchange system as generally shown by reference numeral 11 in FIG. 1, where brokers 10 and providers 20 exchange secondary life insurance.

The invention is directed to an insurance exchange including both viaticals and life settlement. Viaticals can refer to the sale of an in-force life insurance policy on a terminally ill insured, which can be defined as having 2 years or less to live, where the insured is of any age. A life settlement can refer to the sale of an in force life insurance policy on a senior insured, which can be defined as 65 year of age or older, and having any number of years to live. Although the terms viatical or life settlement may be used independently at times in describing the invention, that is not intended to be limiting in any way and the invention encompasses either type of life insurance exchange.

The system includes a life exchange component 30 including a plurality of secondary life insurance policies submitted by brokers registered with the life exchange. Multiple registered providers can receive, request and bid on these policies that meet specified criteria. By sorting and matching uniquely identified cases and providers, exchanges are made.

The life exchange can be referred to as a business to business (B2B) exchange in the life settlement industry with features and functions specifically designed to improve compliance with regulations, increase customer value through systematic bidding, save valuable man hours, create new revenue models (“transactional data”) and add enormous efficiency to an inefficient market.

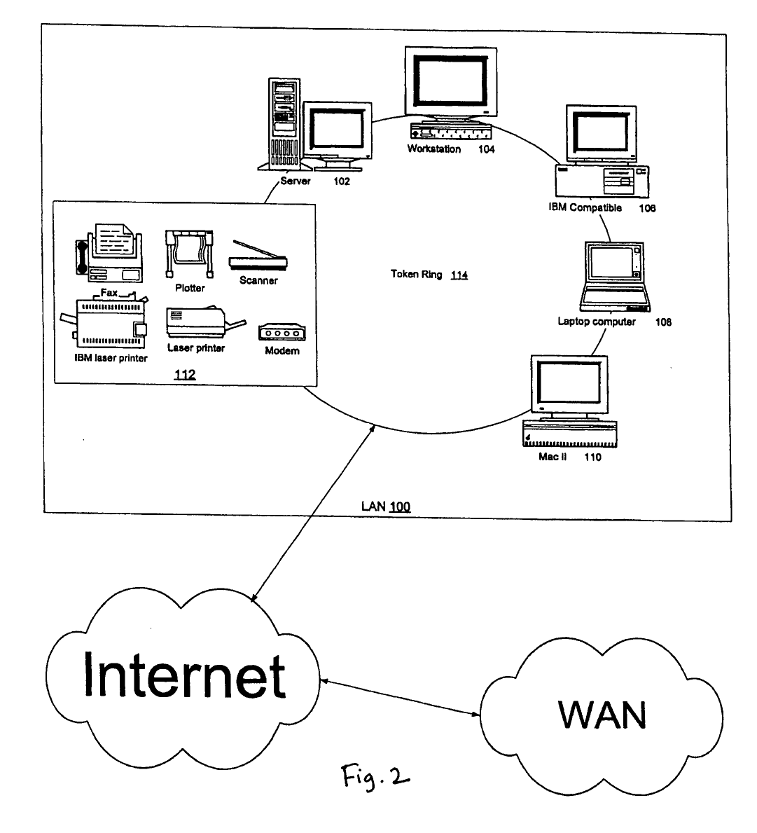

FIG. 2 illustrates a local area network (LAN) 100 that serves as the platform for the life exchange. LAN 100 comprises a server 102, four computer systems 104, 106, 108 and 110, and peripherals, such as printers and other devices 112, that may be shared by components on LAN 100. Computer systems 104, 106, 108 and 110 may serve as clients for server 102 and/or as clients and/or servers for each other and/or for other components connected to LAN 100. Components on LAN 100 are preferably connected together by cable media, for example, copper or fiber-optic cable and the network topology may be a token ring topology 114. It should be apparent to those of ordinary skill in the art that other media, for example, wireless media, such as optical and radio frequency, may also connect LAN 100 components. It should also be apparent that other network topologies, such as Ethernet, may be used.

According to the invention, LAN 100 is connected to the Internet and may be connected to other LANs or Wide Area Networks (WAN). Hence some components of LAN 100 are preferably Web-enabled. The computer processors used to execute the inventive system and method, for example server 102 and/or computer systems 104, 106, 108 and 110, include electronic storage media, such as disks, for storing programming code and data structures used to implement the invention described herein. Note, however, that any computer system may be configured to implement the inventive method and computer systems 104, 106, 108 and 110 are only used for exemplary purposes.

FIG. 2 illustrates participants on LAN 100 alone or, more likely, in combination with other LANs, the WAN or the internet, that provide aspects of the life exchange 40. The participants, generally, can include brokers 10 and providers or funders 20 operating on the system. The life exchange can be maintained on server 102, for example, or at any other location in accordance with the principles of the invention.

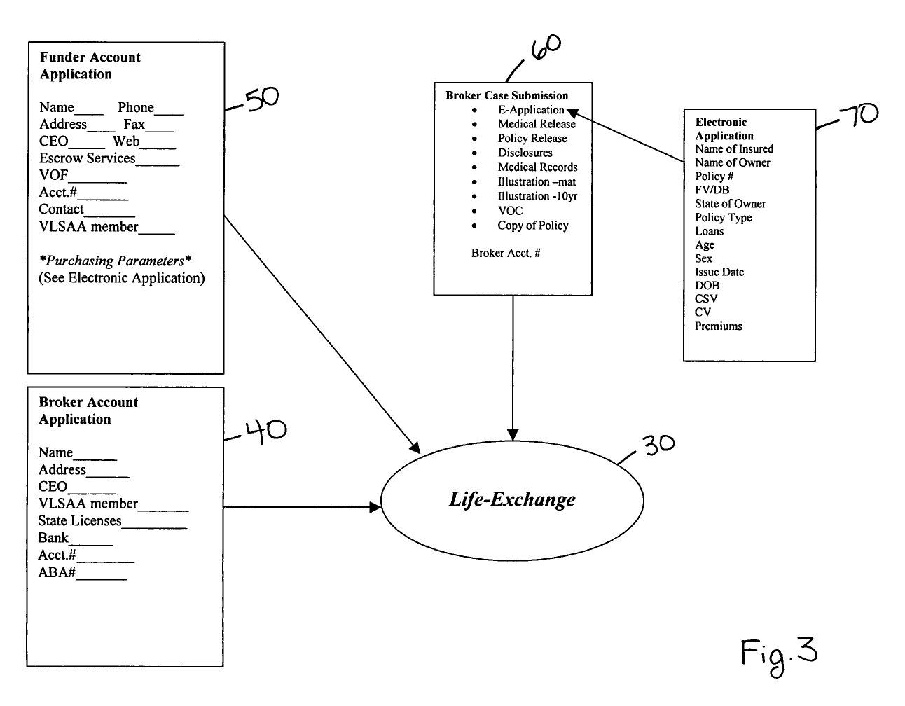

Both the brokers 10 and providers or funders 20 register with the exchange 30. Brokers and funders as discussed herein are not limited to any particular type of entity. For example, although a broker could be a qualified broker in this area, in accordance with the invention brokers can encompass any entity looking to broker a policy, such as the insured, an agent, an estate planner, a CPA, a financial intermediary or otherwise. Similarly, a funder or provider can include any entity or intermediary entity interested in acquiring secondary life insurance. For each registrant in the exchange, user profiles are created in the life exchange component 30. As illustrated in FIG. 3, the broker and funder provide account information. The broker account application 40 can include, for example, the name, address, brokerage firm name, CEO, VLSAA member status, state licenses, bank name, account number and ABA number. The funder account application 50 can include, for example, the name, address, CEO, phone number, facsimile number, web address, the escrow company, verification of funds, account number, contact name, VLSAA member number and purchasing parameters. The purchasing parameters serve as searchable and/or unique identifiers for a policy. The purchasing parameters can include, for example, any of the searchable and/or unique identifiers associated with the insurance policy as shown in FIG. 3 in the electronic application data 70 and discussed below. More specifically, for example, the purchasing parameters can include a policy face value range, policy types, e.g., universal or whole life, the life expectancy range, the states the provider is licensed in, and the age of insured. Typically particularly relevant parameters are the state of ownership of the policy, the state the provider is licensed in, the face value of the policy, the life expectancy range and the age. The purchasing parameters can vary depending upon the requests of the provider 20 and are not limited in quantity or to any particular parameters or combination of parameters.

In accordance with the principles of the invention, however, more, less, or any combination of this information can be provided. The state in which the broker and funder are authorized to work on a life settlement is needed in order to comply with regulations. Life settlements are currently regulated on a state by state basis and that is unlikely to change in the near future. The licensing process for brokers and funders is different for each state. This leaves many gaps in the areas that various brokers and funders are licensed. This complicates compliance. Brokers are not allowed to conduct business and submit cases from states that they are not licensed in and funders are not allowed to buy or review cases in states that they are not licensed. Every week there can be new funders and brokers entering this industry. Having a life insurance policy exchange can allow a broker to complete an application listing and providing evidence of appropriate licenses they hold in each state for conducting business and can automatically reject cases they submit from states for which they have not been cleared. This same function can assist the funders by allowing them to avoid receiving or bidding on files for which they do not hold licenses. Both funders and brokers can have an account to login into so they may view the appropriate files that are being exchanged. Once registered, the exchange can use this information to sort and match information relevant to selling life insurance policies in the exchange. The sorting and matching features can be carried out using customized database software in accordance with the principles of the invention.

The broker is the typical interface with the policy owner or owner's representative. A typical life exchange process begins when a senior insured or terminally insured client decides that they have life insurance that is no longer wanted or affordable. They usually contact their life agent, estate planner or financial planner to let them know that they are going to lapse or surrender their policy, who then contacts a broker. Lapsing a policy means that the policy owner can no longer make the necessary premium payments to keep the policy in force. Surrendering a policy means that the policy owner can surrender their policy back to the life insurance carrier for the left over cash remaining in the policy.

Once the policy owner chooses to surrender the policy a number of steps must be taken to assure that the policy can be transferred successfully to the purchaser. The policy owner needs to complete the appropriate state application, insurance policy release, medical release, and disclosure statement form for their state of residence. The state application can contain basic information about the policy as well as general information about the insured and policy owner, often times the same individual. The insurance policy release is signed so that the brokers and funders may request specific information. The medical release is signed thus allowing the broker or funder to gather the last five (5) years of medical records on the insured. These medical records can be used in determining the life expectancy of the insured. The disclosure statement is signed by the insured and policy owner informing them of a life settlement option and any repercussions from choosing a life settlement.

Upon completion, the information is provided to the broker. Then, the broker can gather medical records and policy information or that can be done through the life exchange. For example, when the broker submits the life insurance case, a life expectancy underwriter can be identified and matched up with the broker through the exchange. Either way, the life expectancy calculation usually is performed by a third party life expectancy underwriter dedicated to evaluating medical records and issue life expectancies. These life expectancies can be used the funders' pricing models to accurately calculate bids for the policies.

The broker can submit this information to the exchange and a life insurance packet or case submission 60 can be created including content uniquely identifying a particular policy and can be referred to as searchable and/or unique identifiers. The unique identifiers can be submitted as part of an electronic application 70. The unique identifiers can include, for example, the name of the insured, the name of the owner of the policy, the policy number, the insurance carrier's name and rating, the face value or death benefit, the owner's state of residence, the policy type, loans against the policy, age of the insured, sex of the insured, issued date of the policy, date of birth of the insured, cash surrender value (CSV), cash value (CV) and premium information. Other searchable and/or unique identifiers can be included. Any of this information can be used in the sort and match feature of the exchange. The case broker submission 60 can include the application containing the searchable or unique identifiers, a medical release, policy release, disclosures, medical records, a maturity illustration (cost to carry the policy to the end), a ten (10) year illustration (cost to carry the policy to 10 years), verification of coverage, and a copy of the policy. The broker can submit this information to the exchange in electronic format. A policy profile is created in the life exchange component 30 to maintain this information. The searchable and/or unique identifier information is maintained in a searchable and sortable format. The life expectancy underwriters are third party underwriters paid to evaluate medical records and issue life expectancies. These life expectancies can be valuable for the funders pricing models to accurately calculate bids for the policies.

A funder registered with the exchange can identify parameters for desired cases. For example, a funder may desire a file that is from a state where they are licensed to do business, that the death benefit (many times referred to as face value) and policy type are within the parameters for purchasing, and/or a life expectancy calculated from the medical records. Based on the type of information, the funder uses a pricing model to figure out what they want to pay for the policy. After funders start submitting bids to the broker through the exchange and other funders can bid, driving the bid higher, until the highest bidder has won the file. Preferably, these bids are confidential. The broker can then present the offer received on the exchange to the insured and if it is accepted contracts can then be drawn up, which also can be arranged through the exchange. Both the funder and the policy owner can sign contracts and final closing can be contingent upon a list of required closing documents from the policy owner (usually things like copy of ID, copies of any trusts, etc.) After all this documentation is completed through the exchange, change of ownership/beneficiary forms can be sent to the life insurance carrier. Once the carrier has completed these forms they can be sent to an escrow company where the life settlement funds can be in an escrow account. The funds can be released to the now former policy owner upon receipt of the forms, and the new ownership/beneficiary forms can be sent to the funder.

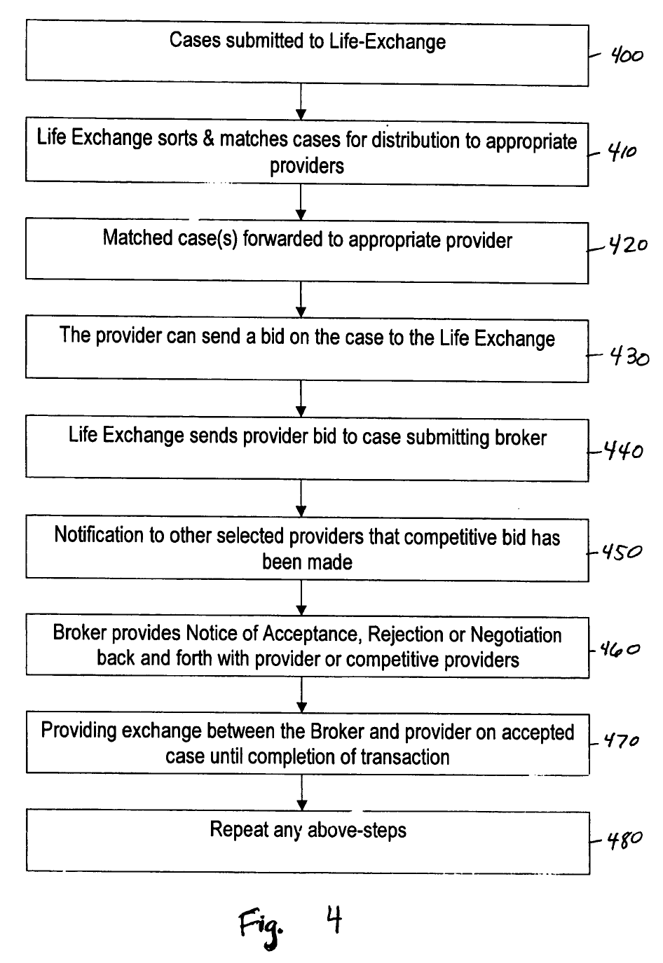

A preferred method of life exchange is described with reference to FIG. 4. The broker can submit life insurance case submissions or packets to the exchange as illustrated in step 400. Upon request, for example by the provider or the broker, the life exchange component 40 sorts and matches cases for distribution to selected providers based upon matching unique identifiers as illustrated in step 410. Typically, the broker initiates the request to the exchange, but the provider or another entity can also make the request in accordance with the invention. The request can be of any scope and can be changed or tailored as desired. The matched case or cases are forwarded to the appropriate provider for consideration as illustrated in step 420. The provider can send a bid to the life exchange bidding on one or more of the cases as illustrated in step 430. The life exchange sends the provider's bid(s) by way of the exchange to the case submitting broker as illustrated in step 440. Notification is provided to the other selected provider that a competitive bid has been made as illustrated in step 450. Notification can be initiated automatically or by the broker. Then, the broker provides a response. The response can include, for example, notification of acceptance, rejection or negotiation as illustrated in step 460. Depending upon the implementation, the order of the steps may vary or be repeated. Moreover, the sorting and matching can identify a single policy or groups of policies that can be provided alone or in a group to the provider or competitive providers. The system provides exchange between the broker(s) and the provider(s) on accepted cases until the completion of the transaction as illustrated in step 470. Any of these steps can be repeated to implement transactions in accordance with the invention as illustrated in step 480.

In addition, the above-described sort and match feature of the exchange can bring liquidity into the area of life settlement. Currently each broker has relationships with different funders. For example most brokers have access to about 7-10 funding sources whereas large brokers have access to 22-30 funding sources. There is a significant amount of capital entering into the life settlement industry and along with a need to place this capital. Allowing more buyers and sellers to transact business in the same location improves market liquidity and value for both parties. Brokers benefit by having equal and greater access to funding sources ensuring their clients receive the highest bids for their policies and maintaining compliance with the stringent state by state regulations. Funders benefit by having access to more case submissions or policies and can place their capital faster and more efficiently while being compliant with insurance regulations.

Additional features of the exchange can include customized emails to alert brokers when a case has been bid on or if there is a need for extra information to evaluate a case instantaneously. Emails can also alert funders when bids come in allowing them the opportunity to place a higher bid to win the file. Other features can include scrolling industry news updates as well as shared application features allowing brokers and funders to work on the cumbersome closing documents once a bid price has been concluded. Other capabilities in the life exchange are contemplated in accordance with the principles of the invention. For example, as discussed above, a life expectancy underwriter can interface with the exchange.

In addition the life exchange can include trading platforms to help with secondary and tertiary markets for life settlements. Many life insurance policies are bought by institutions and placed in large portfolios. Many of these portfolios were bought with the intention of selling them at a higher market price after holding them a few years rather than holding them to maturity. Again the problem arises with the different state regulations making it nearly impossible for an institution to sell an entire portfolio of policies because no two funders share all the same licenses or the same purchase parameters. Therefore, the life exchange can be the place to bring these portfolios. The sorting and matching features can allow a policy to be broken down and maximize its value by selling the policies individually and simultaneously. These same features can work in reverse also for any funder that needs to purchase a portfolio rapidly with specific criteria the exchange can then aggregate cases and put them into a virtual portfolio for bid.

The ever increasing liquidity and desire for secondary life insurance policies can evolve into the securitization of these portfolios. Life settlements are a growing fixed asset class. The life exchange can be designed with bond trading. This can be similar to any other exchange that trades bonds except that this exchange can already have all the industry data critical to traders interested in the buying and selling of these instruments.

The life exchange in accordance with the invention can have multiple revenue models the most significant can start with the transaction fees. When life settlements are conducted they are always evaluated in terms of the face value of the life insurance policy. Face value is considered the maturity amount. The life exchange can charge, for example, 1% of the face amount of each policy successfully traded through the exchange. Based on trading volume this amount may vary.

Another source of revenue can be from subscription fees. These can be accomplished through subscription, i.e., belonging to the exchange or through features in the exchange such as news, etc. Similar to subscription fees, licensing fees can be charged for any proprietary software associated with the exchange data that is leased through the exchange for example proprietary pricing software.

Additionally, fees can be charged for access to or use of the data that has been gathered on the exchange. Buyers of this data could include industry regulators studying activity and changes occurring in the life settlement industry. It could also include, for example, portfolio managers and/or bond traders attempting to identify inefficiencies in the market to exploit additional value. Also, it can include third party financial marketing organizations studying the changing needs of seniors or terminally ill.

Although the foregoing description is directed to the preferred embodiments of the invention, it is noted that other variations and modifications can be apparent to those skilled in the art, and may be made without departing from the spirit or scope of the invention. Moreover, features described in connection with one embodiment of the invention may be used in conjunction with other embodiments, even if not explicitly stated above.

What is claimed is:

1. An insurance exchange product for providing exchange capabilities between brokers and providers, the product comprising:
a broker registration for a broker registered with a life insurance exchange;
a provider registration for a provider registered with the life insurance exchange; and
a life insurance packet submitted to the life insurance exchange, wherein the life insurance packet is capable of being matched with a provider.

2. The product of claim 1, wherein the provider submits a request for a specific life insurance packet.

3. The product of claim 2, wherein the life insurance packet is matched with the request based on searchable unique identifiers.

4. The product of claim 1, wherein the life insurance exchange includes a life insurance exchange component having a database of at least a plurality of life insurance packets.

5. The product of claim 1, wherein the provider has a provider profile with at least one identifier, the life insurance packet has at least one packet identifier and a match is created when the provider profile identifier matches at least one of the packet identifiers.

6. The product of claim 1, wherein the life insurance packet has at least one searchable identifier.

7. The product of claim 6, wherein the life insurance packet includes a life insurance policy type identifier including at least one of a state of ownership of the life insurance policy, a face value of the life insurance policy, a carrier rating, a policy type and a life expectancy range for an individual insured under the life insurance policy.

8. The product of claim 1, further comprising a broker account application.

9. The product of claim 1, further comprising a funder account application.

10. The product of claim 1, wherein the provider has a profile with at least one searchable unique identifier.

11. The product of claim 10, wherein the provider's searchable unique identifier includes at least one purchasing parameter.

12. The product of claim 11, wherein the purchasing parameter includes at least one of a face value range, a policy type, a life expectancy range and a state of licensing.

13. The product of claim 1, further comprising bidding means for the provider to submit to the broker a bid on a life insurance packet to the broker.

14. The product of claim 1, further comprising a plurality of life insurance packets and more than one life insurance packet is matched with a selected provider.

15. The product of claim 1, wherein the broker is a life insurance broker.

16. The product of claim 5, wherein a the life insurance packet is capable of being matched with a selected provider based on matching the identifiers relating to a life insurance policy associated with the life insurance packet.

17. The product of claim 5, wherein one of the broker and the provider initiates a match.

18. The product of claim 1, wherein the insurance exchange product is a life settlement exchange product.

19. The product of claim 1, wherein the insurance exchange product is a viatical exchange product.

20. The product of claim 1, wherein the broker is the insured.

21. A system for providing an insurance exchange, the system comprising:
a) a storage device for storing a plurality of life insurance policy packets and at least one provider profile, wherein each policy packet has a packet identifier and the provider profile has a provider identifier;
b) a sorter for sorting the plurality of policy packets based on the identifiers;
c) a matcher for matching the policy packet and the provider profile based on the identifiers to identify at least one match; and
d) means for forwarding a matched policy packet to the provider.

22. The system of claim 21, wherein the match includes the packet identifier and the policy identifier being the same.

23. The system of claim 21, wherein the match includes a plurality of matches.

24. The system of claim 21, wherein the packet identifier includes a plurality of searchable parameters.

25. The system of claim 24, wherein the parameters include at least one of a state of ownership of the life insurance policy, a face value of the life insurance policy and a life expectancy range for an individual insured under the life insurance policy.

26. The system of claim 21, wherein the provider identifier includes a plurality of searchable parameters.

27. The system of claim 21, further comprising a means for bidding on the matched policy packet.

28. The system of claim 25, wherein the parameters include at least one of a face value range, a policy type, a life expectancy range and a state of licensing.

29. The system of claim 25, wherein the insurance exchange product is a life settlement exchange product.

30. The system of claim 25, wherein the insurance exchange product is a viatical exchange product.

31. A computer implemented method of providing an insurance exchange, the method comprising:
a) submitting insurance policy data for a plurality of life insurance policies into a life exchange component, wherein each insurance policy has a profile;
b) requesting identification of at least one policy having a requested profile;
c) sorting the insurance policy data to identify at least one matched life insurance policy based on the requested profile;
d) sending the at least one matched life insurance policy, if identified, to the requestor; and
e) allowing the requestor to submit through the life exchange component a bid to purchase the matched life insurance policy.

32. The method according to claim 31, further comprising the step of repeating any of steps (a)-(e).

33. The method according to claim 31, further comprising providing notice to providers once a bid is made on the match.

34. The method according to claim 31, wherein the step of sorting includes identifying a plurality of matched life insurance policies and bundling them into a portfolio.

35. The method according to claim 31, wherein the method provides for a life settlement exchange.

36. The method according to claim 31, wherein the method provides for a viatical exchange.
